(19) United States
(12) Patent Application Publication
(10) Pub. No.: US 2011/0104970 A1
(43) Pub. Date: May 5, 2011

(54) LOW LINT FIBROUS STRUCTURES AND METHODS FOR MAKING SAME

(76) Inventors: Steven Lee Barnholtz, West Chester, OH (US); Michael Donald Suer, Cincinnati, OH (US); Paul Dennis Trokhan, Hamilton, OH (US)

(21) Appl. No.: 12/917,574

(22) Filed: Nov. 2, 2010

Related U.S. Application Data
(60) Provisional application No. 61/257,270, filed on Nov. 2, 2009.

(51) Int. Cl. D04H 13/00; C08L 23/12; C08L 23/06; C08L 67/00; C08K 7/02; D03D 19/00

(52) U.S. Cl. 442/1; 428/297.4; 428/292.4; 524/582; 524/585; 524/599; 524/13

(57) ABSTRACT

Fibrous structures that exhibit low dry lint scores, and more particularly fibrous structures containing filaments and solid additives that exhibit low dry lint scores and methods for making such fibrous structures are provided.

### CROSS REFERENCE TO RELATED APPLICATION

This application claims the benefit of U.S. Provisional Application No. 61/257,270, filed Nov. 2, 2009.

### FIELD OF THE INVENTION

The present invention relates to fibrous structures that exhibit low dry lint scores, and more particularly to fibrous structures comprising filaments and solid additives that exhibit low dry lint scores and methods for making such fibrous structures.

### BACKGROUND OF THE INVENTION

In the area of consumer products, especially consumer products employing fibrous structures, such as sanitary tissue products, consumers integrate multiple properties to assess their overall impression of a product. For the product developer it often becomes a trade-off between improving one relevant property albeit at the expense of another relevant property. A classic example of this dilemma is increasing the softness of a product, an improvement to the consumer, while also increasing the product's lint, a negative to the consumer. The challenge to the product developer is to reduce a fibrous structure's dry lint without negatively impacting Between the consumer's desirable goal of having zero lint and a product with a very small amount of lint there is little effect on the consumer's impression of the product. However, as a product continues to increase the amount of lint observed by the consumer it begins to have a disproportionately negative impact on their impression of the product as the product no longer meets her needs for her desired tasks.

Formulators have developed fibrous structures that comprise a plurality of pulp fibers and greater than 30% by weight of the fibrous structure of filaments with low lint, but have been unsuccessful in producing fibrous structures that contain a plurality of solid additives, such as pulp fibers, and less than 30% by weight of the fibrous structure of filaments that exhibit low lint, for example a dry lint score of less than 2.5.

Accordingly, there is a need for fibrous structures that exhibit low dry lint scores and methods for making such low lint fibrous structures.

### SUMMARY OF THE INVENTION

The present invention fulfills the need described above by providing fibrous structures that exhibit low dry lint scores and methods for making such low lint fibrous structures.

In one example of the present invention, a fibrous structure comprising a plurality of filaments and a plurality of solid additives, wherein the fibrous structure exhibits a dry lint score of less than 2.5 as measured according to the Lint Test Method described herein, and wherein the filaments are present in the fibrous structure at a level of less than 30% by weight of the fibrous structure, is provided.

In another example of the present invention, a fibrous structure comprising a plurality of filaments and a plurality of solid additives, wherein the fibrous structure exhibits a dry lint score of less than 2.5 as measured according to the Lint Test Method described herein and a vertical full sheet (VFS) of greater than 11 g/g as measured according to the VFS Test Method described herein, is provided.

In yet another example of the present invention, a fibrous structure comprising a plurality of filaments and a plurality of solid additives, wherein the fibrous structure exhibits a dry lint score differential between two surfaces of the fibrous structure of less than 0.5 as measured according to the Lint Test Method described herein and wherein the filaments are present in the fibrous structure at a level of less than 30% by weight of the fibrous structure, is provided.

In even another example of the present invention, a fibrous structure comprising a plurality of filaments and a plurality of solid additives, wherein the fibrous structure exhibits a dry lint score differential between two surfaces of the fibrous structure of less than 0.5 as measured according to the Lint Test Method described herein and a VFS of greater than 11 g/g as measured according to the VFS Test Method described herein, is provided.

In even yet another example of the present invention, a single- or multi-ply sanitary tissue product comprising one or more fibrous structures according to the present invention, is provided.

In still yet another example of the present invention, a method for making a fibrous structure, the method comprising the step of combining a plurality of filaments and a plurality of solid additives such that a fibrous structure containing less than 30% by weight of the filaments and exhibiting a dry lint score of less than 2.5 as measured according to the Lint Test Method described herein is formed, is provided.

In even still yet another example of the present invention, a method for making a fibrous structure, the method comprising the step of combining a plurality of filaments and a plurality of solid additives such that a fibrous structure that exhibits a dry lint score of less than 2.5 as measured according to the Lint Test Method described herein and a VFS of greater than 11 g/g as measured according to the VFS Test Method described herein is formed, is provided.

In still yet another example of the present invention, a method for making a fibrous structure, the method comprising the step of combining a plurality of filaments and a plurality of solid additives such that a fibrous structure containing less than 30% by weight of the fibrous structure of filaments and exhibits a dry lint score differential of less than 0.5 as measured according to the Lint Test Method is formed, is provided.

In another example of the present invention, a method making a fibrous structure, the method comprising the step of combining a plurality of filaments and a plurality of solid additives such that a fibrous structure that exhibits a dry lint score differential of less than 0.5 as measured according to the Lint Test Method described herein and a VFS of greater than 11 g/g as measured according to the VFS Test Method described herein is formed, is provided.

Accordingly, the present invention provides a fibrous structure that exhibits low dry lint score and a method for making such fibrous structures.

### BRIEF DESCRIPTION OF THE DRAWINGS

FIG. 1 is a schematic representation of an example of a fibrous structure according to the present invention;

FIG. 2 is a schematic, cross-sectional representation of FIG. 1 taken along line 2-2;

FIG. 3 is a scanning electromicrophotograph of a cross-section of another example of fibrous structure according to the present invention;

FIG. 4 is a schematic representation of another example of a fibrous structure according to the present invention;

FIG. 5 is a schematic, cross-sectional representation of another example of a fibrous structure according to the present invention;

FIG. 6 is a schematic, cross-sectional representation of another example of a fibrous structure according to the present invention;

FIG. 7 is a schematic representation of an example of a process for making a fibrous structure according to the present invention;

FIG. 8 is a schematic representation of an example of a patterned belt for use in a process according to the present invention;

FIG. 9 is a schematic representation of an example of a filament-forming hole and fluid-releasing hole from a suitable die useful in making a fibrous structure according to the present invention;

FIG. 10 is a diagram of a support rack utilized in the VFS Test Method described herein; FIG. 10A is a cross-sectional view of FIG. 10;

FIG. 11 is a diagram of a support rack cover utilized in the VFS Test Method described herein; and FIG. 11A is a cross-sectional view of FIG. 11.

### DETAILED DESCRIPTION OF THE INVENTION

### Definitions

“Fibrous structure” as used herein means a structure that comprises one or more filaments and/or fibers. In one example, a fibrous structure according to the present invention means an orderly arrangement of filaments and/or fibers within a structure in order to perform a function. In another example, a fibrous structure according to the present invention is a nonwoven.

Non-limiting examples of processes for making fibrous structures include known wet-laid papermaking processes and air-laid papermaking processes. Such processes typically include steps of preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fibrous slurry is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, and may subsequently be converted into a finished product, e.g. a sanitary tissue product.

The fibrous structures of the present invention may be homogeneous or may be layered. If layered, the fibrous structures may comprise at least two and/or at least three and/or at least four and/or at least five layers.

The fibrous structures of the present invention may be co-formed fibrous structures.

“Co-formed fibrous structure” as used herein means that the fibrous structure comprises a mixture of at least two different materials wherein at least one of the materials comprises a filament, such as a polypropylene filament, and at least one other material, different from the first material, comprises a solid additive, such as a fiber and/or a particulate. In one example, a co-formed fibrous structure comprises solid additives, such as fibers, such as wood pulp fibers and/or absorbent gel materials and/or filler particles and/or particulate spot bonding powders and/or clays, and filaments, such as polypropylene filaments.

“Solid additive” as used herein means a fiber and/or a particulate.

“Particulate” as used herein means a granular substance or powder.

“Fiber” and/or “Filament” as used herein means an elongate particulate having an apparent length greatly exceeding its apparent width, i.e. a length to diameter ratio of at least about 10. For purposes of the present invention, a “fiber” is an elongate particulate as described above that exhibits a length of less than 5.08 cm (2 in.) and a “filament” is an elongate particulate as described above that exhibits a length of greater than or equal to 5.08 cm (2 in.).

Fibers are typically considered discontinuous in nature. Non-limiting examples of fibers include wood pulp fibers and synthetic staple fibers such as polyester fibers.

Filaments are typically considered continuous or substantially continuous in nature. Filaments are relatively longer than fibers. Non-limiting examples of filaments include meltblown and/or spunbond filaments. Non-limiting examples of materials that can be spun into filaments include natural polymers, such as starch, starch derivatives, cellulose and cellulose derivatives, hemicellulose, hemicellulose derivatives, chitin, chitosan, polyisoprene (cis and trans), peptides, polyhydroxyalkanoates, and synthetic polymers including, but not limited to, thermoplastic polymer filaments comprising thermoplastic polymers, such as polyesters, nylons, polyolefins such as polypropylene filaments, polyethylene filaments, polyvinyl alcohol and polyvinyl alcohol derivatives, sodium polyacrylate (absorbent gel material) filaments, and copolymers of polyolefins such as polyethylene-octene, and biodegradable or compostable thermoplastic fibers such as polylactic acid filaments, polyvinyl alcohol filaments, and polycaprolactone filaments. The filaments may be monocomponent or multicomponent, such as bicomponent filaments.

In one example of the present invention, “fiber” refers to papermaking fibers. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. U.S. Pat. No. 4,300,981 and U.S. Pat. No. 3,994,771 are incorporated herein by reference for the purpose of disclosing layering of hardwood and softwood fibers. Also applicable to the present invention are fibers derived from recycled paper, which may contain any or all of the above categories as well as other non-fibrous materials such as fillers and adhesives used to facilitate the original papermaking.

In addition to the various wood pulp fibers, other cellulosic fibers such as cotton linters, rayon, lyocell and bagasse can be used in this invention. Other sources of cellulose in the form of fibers or capable of being spun into fibers include grasses and grain sources.

“Sanitary tissue product” as used herein means a soft, low density (i.e.<about 0.15 g/cm³) web useful as a wiping implement for post-urinary and post-bowel movement cleaning (toilet tissue), for otorhinolaryngological discharges (facial tissue), and multi-functional absorbent and cleaning uses (absorbent towels). Non-limiting examples of suitable sanitary tissue products of the present invention include paper towels, bath tissue, facial tissue, napkins, baby wipes, adult wipes, wet wipes, cleaning wipes, polishing wipes, cosmetic wipes, car care wipes, wipes that comprise an active agent for performing a particular function, cleaning substrates for use with implements, such as a Swiffer® cleaning wipe/pad. The sanitary tissue product may be convolutedly wound upon itself about a core or without a core to form a sanitary tissue product roll.

In one example, the sanitary tissue product of the present invention comprises a fibrous structure according to the present invention.

The sanitary tissue products of the present invention may exhibit a basis weight between about 10 g/m² to about 120 g/m² and/or from about 15 g/m² to about 110 g/m² and/or from about 20 g/m² to about 100 g/m² and/or from about 30 to 90 g/m². In addition, the sanitary tissue product of the present invention may exhibit a basis weight between about 40 g/m² to about 120 g/m² and/or from about 50 g/m² to about 110 g/m² and/or from about 55 g/m² to about 105 g/m² and/or from about 60 to 100 g/m².

The sanitary tissue products of the present invention may exhibit a total dry tensile strength of at least 59 g/cm (150 g/in) and/or from about 78 g/cm (200 g/in) to about 394 g/cm (1000 g/in) and/or from about 98 g/cm (250 g/in) to about 335 g/cm (850 g/in). In addition, the sanitary tissue product of the present invention may exhibit a total dry tensile strength of at least 196 g/cm (500 g/in) and/or from about 196 g/cm (500 g/in) to about 394 g/cm (1000 g/in) and/or from about 216 g/cm (550 g/in) to about 335 g/cm (850 g/in) and/or from about 236 g/cm (600 g/in) to about 315 g/cm (800 g/in). In one example, the sanitary tissue product exhibits a total dry tensile strength of less than about 394 g/cm (1000 g/in) and/or less than about 335 g/cm (850 g/in).

In another example, the sanitary tissue products of the present invention may exhibit a total dry tensile strength of at least 196 g/cm (500 g/in) and/or at least 236 g/cm (600 g/in) and/or at least 276 g/cm (700 g/in) and/or at least 315 g/cm (800 g/in) and/or at least 354 g/cm (900 g/in) and/or at least 394 g/cm (1000 g/in) and/or from about 315 g/cm (800 g/in) to about 1968 g/cm (5000 g/in) and/or from about 354 g/cm (900 g/in) to about 1181 g/cm (3000 g/in) and/or from about 354 g/cm (900 g/in) to about 984 g/cm (2500 g/in) and/or from about 394 g/cm (1000 g/in) to about 787 g/cm (2000 g/in).

The sanitary tissue products of the present invention may exhibit an initial total wet tensile strength of less than about 78 g/cm (200 g/in) and/or less than about 59 g/cm (150 g/in) and/or less than about 39 g/cm (100 g/in) and/or less than about 29 g/cm (75 g/in).

The sanitary tissue products of the present invention may exhibit an initial total wet tensile strength of at least 118 g/cm (300 g/in) and/or at least 157 g/cm (400 g/in) and/or at least 196 g/cm (500 g/in) and/or at least 236 g/cm (600 g/in) and/or at least 276 g/cm (700 g/in) and/or at least 315 g/cm (800 g/in) and/or at least 354 g/cm (900 g/in) and/or at least 394 g/cm (1000 g/in) and/or from about 118 g/cm (300 g/in) to about 1968 g/cm (5000 g/in) and/or from about 157 g/cm (400 g/in) to about 1181 g/cm (3000 g/in) and/or from about 196 g/cm (500 g/in) to about 984 g/cm (2500 g/in) and/or from about 196 g/cm (500 g/in) to about 787 g/cm (2000 g/in) and/or from about 196 g/cm (500 g/in) to about 591 g/cm (1500 g/in).

The sanitary tissue products of the present invention may exhibit a density (measured at 95 g/in²) of less than about 0.60 g/cm³ and/or less than about 0.30 g/cm³ and/or less than about 0.20 g/cm³ and/or less than about 0.10 g/cm³ and/or less than about 0.07 g/cm³ and/or less than about 0.05 g/cm³ and/or from about 0.01 g/cm³ to about 0.20 g/cm³ and/or from about 0.02 g/cm³ to about 0.10 g/cm³.

The sanitary tissue products of the present invention may exhibit a Vertical Full Sheet (VFS) value as determined by the Vertical Full Sheet (VFS) Test Method described herein of at least 5 g/g and/or at least 7 g/g and/or at least 9 g/g and/or from about 9 g/g to about 30 g/g and/or to about 25 g/g and/or to about 20 g/g and/or to about 17 g/g.

The sanitary tissue products of the present invention may be in the form of sanitary tissue product rolls. Such sanitary tissue product rolls may comprise a plurality of connected, but perforated sheets of fibrous structure, that are separably dispensable from adjacent sheets. In one example, one or more ends of the roll of sanitary tissue product may comprise an adhesive and/or dry strength agent to mitigate the loss of fibers, especially wood pulp fibers from the ends of the roll of sanitary tissue product.

The sanitary tissue products of the present invention may comprises additives such as softening agents, temporary wet strength agents, permanent wet strength agents, bulk softening agents, lotions, silicones, wetting agents, latexes, especially surface-pattern-applied latexes, dry strength agents such as carboxymethylcellulose and starch, and other types of additives suitable for inclusion in and/or on sanitary tissue products.

“Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121.

“Basis Weight” as used herein is the weight per unit area of a sample reported in lbs/3000 ft² or g/m².

“Apparent Density” or “Density” as used herein means the basis weight of a sample divided by the caliper with appropriate conversions incorporated therein. Apparent density used herein has the units g/cm³ (alternatively g/cc).

“Bulk Density” as used herein means the apparent density of an entire fibrous structure product rather than a discrete area thereof.

“Machine Direction” or “MD” as used herein means the direction parallel to the flow of the fibrous structure through the fibrous structure making machine and/or sanitary tissue product manufacturing equipment.

“Cross Machine Direction” or “CD” as used herein means the direction parallel to the width of the fibrous structure making machine and/or sanitary tissue product manufacturing equipment and perpendicular to the machine direction.

“Dry Lint Score” as used herein for a fibrous structure is measured according to the Lint Test Method described herein.

“Dry Lint Score Differential” as used herein for a fibrous structure is measured according to the Lint Test Method described herein.

“Vertical Full Sheet (VFS)” as use herein for a fibrous structure is measured according to the Vertical Full Sheet (VFS) Test Method described herein.

“Ply” as used herein means an individual, integral fibrous structure.

“Plies” as used herein means two or more individual, integral fibrous structures disposed in a substantially contiguous, face-to-face relationship with one another, forming a multi-ply fibrous structure and/or multi-ply sanitary tissue product. It is also contemplated that an individual, integral fibrous structure can effectively form a multi-ply fibrous structure, for example, by being folded on itself.

As used herein, the articles “a” and “an” when used herein, for example, “an anionic surfactant” or “a fiber” is understood to mean one or more of the material that is claimed or described.

All percentages and ratios are calculated by weight unless otherwise indicated. All percentages and ratios are calculated based on the total composition unless otherwise indicated.

Unless otherwise noted, all component or composition levels are in reference to the active level of that component or composition, and are exclusive of impurities, for example, residual solvents or by-products, which may be present in commercially available sources.

### Fibrous Structure

The fibrous structures of the present invention comprise a plurality of filaments, such as polypropylene filaments, and a plurality of solid additives, such as fibers.

In one example, the fibrous structures of the present invention exhibit a dry lint score of less than 2.5 and/or less than 2.3 and/or less than 2.1 and/or to about 1.1 as measured according to the Lint Test Method described herein.

In another example, the fibrous structures of the present invention exhibit a dry lint score differential of less than 0.5 and/or less than 0.4 and/or less than 0.3 and/or to about 0 and/or to about 0.1 and/or to about 0.2 as measured according to the Lint Test Method described herein.

In one example, the fibrous structures of the present invention comprise less than 5% and/or less than 3% and/or less than 1% and/or 0% by weight of the fibrous structure of a surface binding agent such as latex that is typically sprayed on, printed on, brushed on, foam on to a surface of a fibrous structure to control lint. In other words, the fibrous structures of the present invention may be void of a surface binding agent.

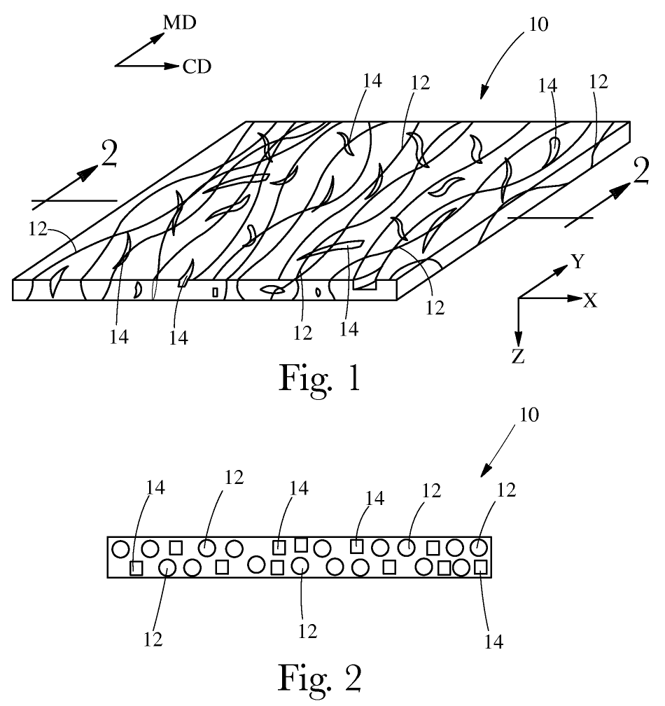

FIGS. 1 and 2 show schematic representations of an example of a fibrous structure in accordance with the present invention. As shown in FIGS. 1 and 2, the fibrous structure 10 may be a co-formed fibrous structure. The fibrous structure 10 comprises a plurality of filaments 12, such as polypropylene filaments, and a plurality of solid additives, such as wood pulp fibers 14. The filaments 12 may be randomly arranged as a result of the process by which they are spun and/or formed into the fibrous structure 10. The wood pulp fibers 14, may be randomly dispersed throughout the fibrous structure 10 in the x-y plane. The wood pulp fibers 14 may be non-randomly dispersed throughout the fibrous structure in the z-direction. In one example (not shown), the wood pulp fibers 14 are present at a higher concentration on one or more of the exterior, x-y plane surfaces than within the fibrous structure along the z-direction.

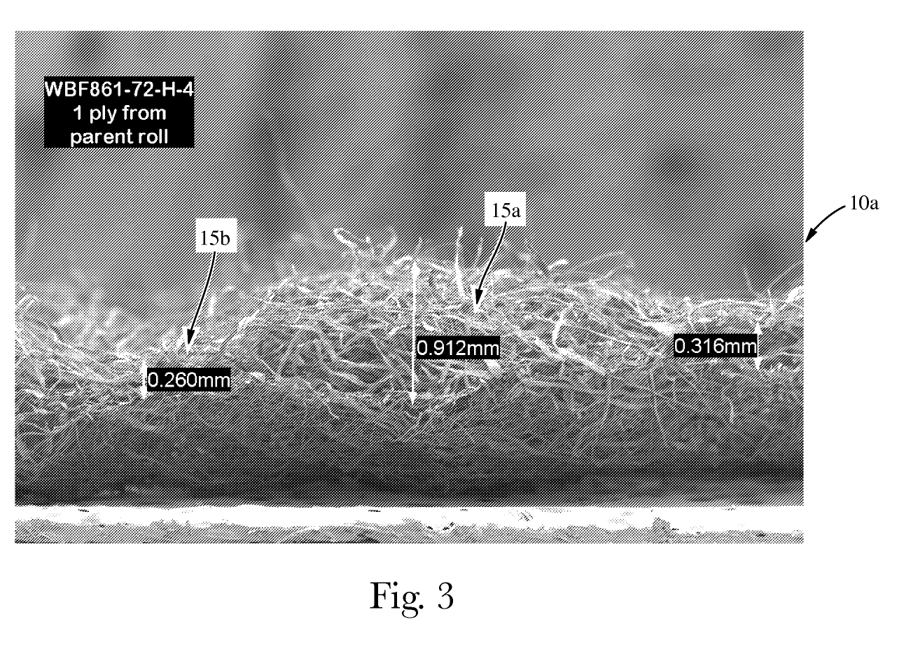

FIG. 3 shows a cross-sectional, SEM microphotograph of another example of a fibrous structure 10a in accordance with the present invention shows a fibrous structure 10a comprising a non-random, repeating pattern of microregions 15a and 15b. The microregion 15a (typically referred to as a “pillow”) exhibits a different value of a common intensive property than microregion 15b (typically referred to as a “knuckle”). In one example, the microregion 15b is a continuous or semi-continuous network and the microregion 15a are discrete regions within the continuous or semi-continuous network. The common intensive property may be caliper. In another example, the common intensive property may be density.

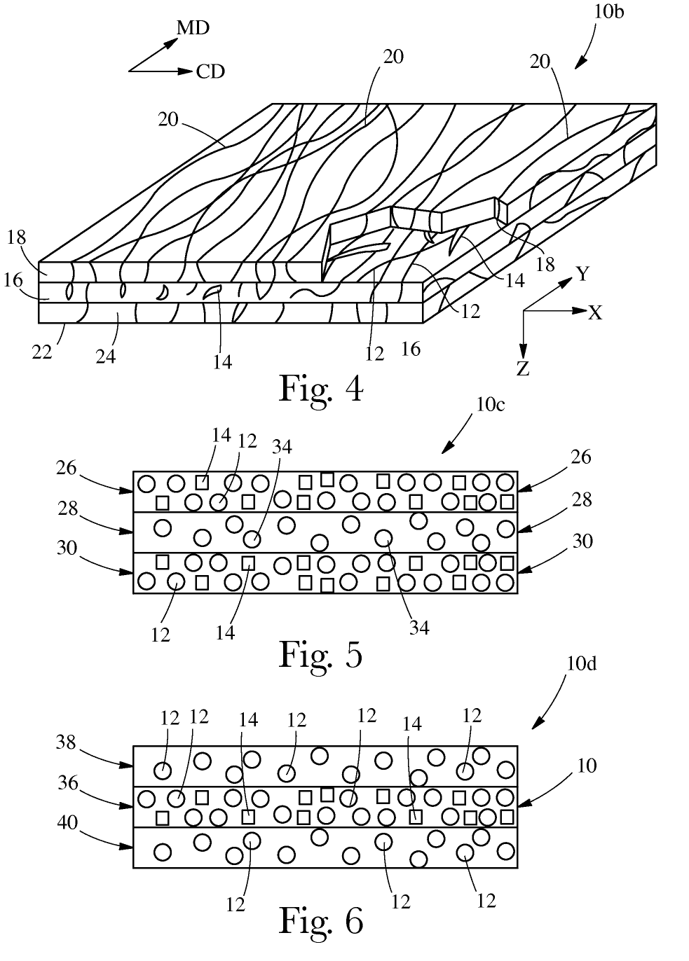

As shown in FIG. 4, another example of a fibrous structure in accordance with the present invention is a layered fibrous structure 10b. The layered fibrous structure 10b comprises a first layer 16 comprising a plurality of filaments 12, such as polypropylene filaments, and a plurality of solid additives, in this example, wood pulp fibers 14. The layered fibrous structure 10b further comprises a second layer 18 comprising a plurality of filaments 20, such as polypropylene filaments. In one example, the first and second layers 16, 18, respectively, are sharply defined zones of concentration of the filaments and/or solid additives. The plurality of filaments 20 may be deposited directly onto a surface of the first layer 16 to form a layered fibrous structure that comprises the first and second layers 16, 18, respectively.

Further, the layered fibrous structure 10b may comprise a third layer 22, as shown in FIG. 4. The third layer 22 may comprise a plurality of filaments 24, which may be the same or different from the filaments 20 and/or 16 in the second 18 and/or first 16 layers. As a result of the addition of the third layer 22, the first layer 16 is positioned, for example sandwiched, between the second layer 18 and the third layer 22. The plurality of filaments 24 may be deposited directly onto a surface of the first layer 16, opposite from the second layer, to form the layered fibrous structure 10b that comprises the first, second and third layers 16, 18, 22, respectively.

As shown in FIG. 5, a cross-sectional schematic representation of another example of a fibrous structure in accordance with the present invention comprising a layered fibrous structure 10c is provided. The layered fibrous structure 10c comprises a first layer 26, a second layer 28 and optionally a third layer 30. The first layer 26 comprises a plurality of filaments 12, such as polypropylene filaments, and a plurality of solid additives, such as wood pulp fibers 14. The second layer 28 may comprise any suitable filaments, solid additives and/or polymeric films. In one example, the second layer 28 comprises a plurality of filaments 34. In one example, the filaments 34 comprise a polymer selected from the group consisting of: polysaccharides, polysaccharide derivatives, polyvinylalcohol, polyvinylalcohol derivatives and mixtures thereof.

In another example of a fibrous structure in accordance with the present invention, instead of being layers of fibrous structure 10c, the material forming layers 26, 28 and 30, may be in the form of plies wherein two or more of the plies may be combined to form a fibrous structure. The plies may be bonded together, such as by thermal bonding and/or adhesive bonding, to form a multi-ply fibrous structure.

Another example of a fibrous structure of the present invention in accordance with the present invention is shown in FIG. 6. The fibrous structure 10d may comprise two or more plies, wherein one ply 36 comprises any suitable fibrous structure in accordance with the present invention, for example fibrous structure 10 as shown and described in FIGS. 1 and 2 and another ply 38 comprising any suitable fibrous structure, for example a fibrous structure comprising filaments 12, such as polypropylene filaments. The fibrous structure of ply 38 may be in the form of a net and/or mesh and/or other structure that comprises pores that expose one or more portions of the fibrous structure 10d to an external environment and/or at least to liquids that may come into contact, at least initially, with the fibrous structure of ply 38. In addition to ply 38, the fibrous structure 10d may further comprise ply 40. Ply 40 may comprise a fibrous structure comprising filaments 12, such as polypropylene filaments, and may be the same or different from the fibrous structure of ply 38.

Two or more of the plies 36, 38 and 40 may be bonded together, such as by thermal bonding and/or adhesive bonding, to form a multi-ply fibrous structure. After a bonding operation, especially a thermal bonding operation, it may be difficult to distinguish the plies of the fibrous structure 10d and the fibrous structure 10d may visually and/or physically be a similar to a layered fibrous structure in that one would have difficulty separating the once individual plies from each other. In one example, ply 36 may comprise a fibrous structure that exhibits a basis weight of at least about 15 g/m² and/or at least about 20 g/m² and/or at least about 25 g/m² and/or at least about 30 g/m² up to about 120 g/m² and/or 100 g/m² and/or 80 g/m² and/or 60 g/m² and the plies 38 and 42, when present, independently and individually, may comprise fibrous structures that exhibit basis weights of less than about 10 g/m² and/or less than about 7 g/m² and/or less than about 5 g/m² and/or less than about 3 g/m² and/or less than about 2 g/m² and/or to about 0 g/m² and/or 0.5 g/m².

Plies 38 and 40, when present, may help retain the solid additives, in this case the wood pulp fibers 14, on and/or within the fibrous structure of ply 36 thus reducing lint and/or dust (as compared to a single-ply fibrous structure comprising the fibrous structure of ply 36 without the plies 38 and 40) resulting from the wood pulp fibers 14 becoming free from the fibrous structure of ply 36.

The fibrous structures of the present invention may comprise any suitable amount of filaments and any suitable amount of solid additives. For example, the fibrous structures may comprise from about 10% to about 70% and/or from about 20% to about 60% and/or from about 30% to about 50% by dry weight of the fibrous structure of filaments and from about 90% to about 30% and/or from about 80% to about 40% and/or from about 70% to about 50% by dry weight of the fibrous structure of solid additives, such as wood pulp fibers.

In one example, the fibrous structures of the present invention comprise less than 30% and/or less than 25% and/or less than 20% and/or less than 15% and/or to about 10% by weight of the fibrous structure of filaments. The level of filaments within the fibrous structures of the present invention can be measured by the Basis Weight Test Method described herein.

In one example, the fibrous structures of the present invention may comprise at least 70% and/or at least 75% and/or at least 80% and/or at least 85% and/or to about 90% by weight of the fibrous structures of solid additives, such as fibers. The level of solid additives within the fibrous structures of the present invention can be measured by the Basis Weight Test Method described herein.

The filaments and solid additives of the present invention may be present in fibrous structures according to the present invention at weight ratios of filaments to solid additives of from at least about 1:1 and/or at least about 1:1.5 and/or at least about 1:2 and/or at least about 1:2.5 and/or at least about 1:3 and/or at least about 1:4 and/or at least about 1:5 and/or at least about 1:7 and/or at least about 1:10.

The fibrous structures of the present invention and/or any sanitary tissue products comprising such fibrous structures may be subjected to any post-processing operations such as embossing operations, printing operations, tuft-generating operations, thermal bonding operations, ultrasonic bonding operations, perforating operations, surface treatment operations such as application of lotions, silicones and/or other materials and mixtures thereof.

Non-limiting examples of suitable polypropylenes for making the filaments of the present invention are commercially available from Lyondell-Basell and Exxon-Mobil.

Any hydrophobic or non-hydrophilic materials within the fibrous structure, such as polypropylene filaments, may be surface treated and/or melt treated with a hydrophilic modifier. Non-limiting examples of surface treating hydrophilic modifiers include surfactants, such as Triton X-100. Non-limiting examples of melt treating hydrophilic modifiers that are added to the melt, such as the polypropylene melt, prior to spinning filaments, include hydrophilic modifying melt additives such as VW351 and/or S-1416 commercially available from Polyvel, Inc. and Irgasurf commercially available from Ciba. The hydrophilic modifier may be associated with the hydrophobic or non-hydrophilic material at any suitable level known in the art. In one example, the hydrophilic modifier is associated with the hydrophobic or non-hydrophilic material at a level of less than about 20% and/or less than about 15% and/or less than about 10% and/or less than about 5% and/or less than about 3% to about 0% by dry weight of the hydrophobic or non-hydrophilic material.

The fibrous structures of the present invention may include optional additives, each, when present, at individual levels of from about 0% and/or from about 0.01% and/or from about 0.1% and/or from about 1% and/or from about 2% to about 95% and/or to about 80% and/or to about 50% and/or to about 30% and/or to about 20% by dry weight of the fibrous structure. Non-limiting examples of optional additives include permanent wet strength agents, temporary wet strength agents, dry strength agents such as carboxymethylcellulose and/or starch, softening agents, lint reducing agents, opacity increasing agents, wetting agents, odor absorbing agents, perfumes, temperature indicating agents, color agents, dyes, osmotic materials, microbial growth detection agents, antibacterial agents and mixtures thereof.

The fibrous structure of the present invention may itself be a sanitary tissue product. It may be convolutedly wound about a core to form a roll. It may be combined with one or more other fibrous structures as a ply to form a multi-ply sanitary tissue product. In one example, a co-formed fibrous structure of the present invention may be convolutedly wound about a core to form a roll of co-formed sanitary tissue product. The rolls of sanitary tissue products may also be coreless.

### Method For Making A Fibrous Structure

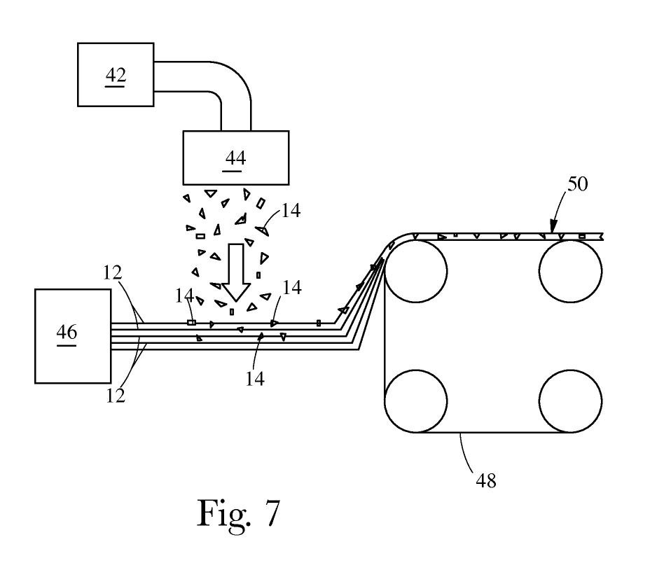

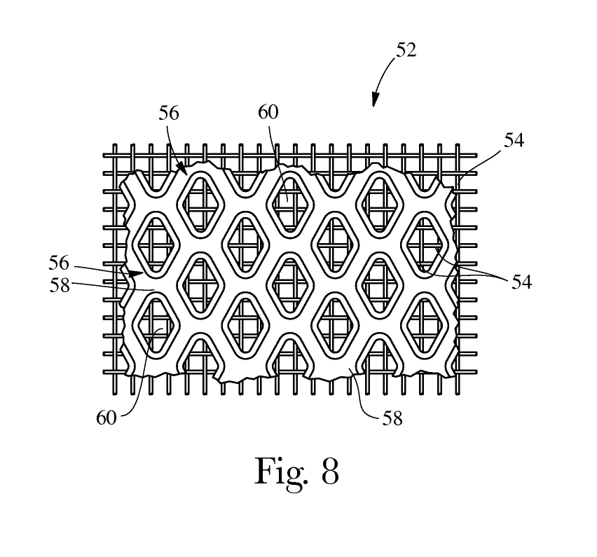

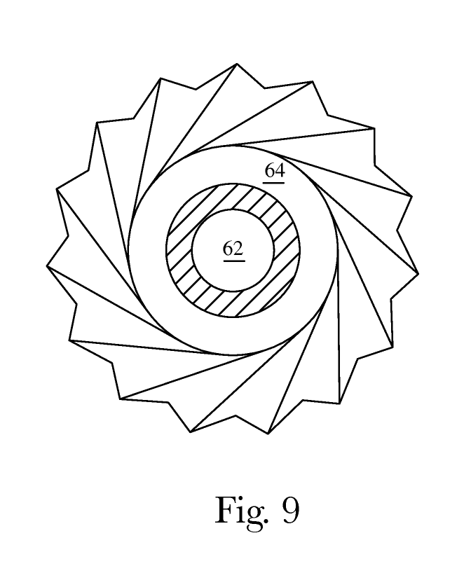

A non-limiting example of a method for making a fibrous structure according to the present invention is represented in FIG. 7. The method shown in FIG. 7 comprises the step of mixing a plurality of solid additives 14 with a plurality of filaments 12. In one example, the solid additives 14 are wood pulp fibers, such as SSK fibers and/or Eucalyptus fibers, and the filaments 12 are polypropylene filaments. The solid additives 14 may be combined with the filaments 12, such as by being delivered to a stream of filaments 12 from a hammermill 42 via a solid additive spreader 44 to form a mixture of filaments 12 and solid additives 14. The filaments 12 may be created by meltblowing from a meltblow die 46. The mixture of solid additives 14 and filaments 12 are collected on a collection device, such as a belt 48 to form a fibrous structure 50. The collection device may be a patterned and/or molded belt that results in the fibrous structure exhibiting a surface pattern, such as a non-random, repeating pattern of microregions. The patterned belt may have a three-dimensional pattern on it that gets imparted to the fibrous structure 50 during the process. For example, the patterned belt 52, as shown in FIG. 8, may comprise a reinforcing structure, such as a fabric 54, upon which a polymer resin 56 is applied in a pattern. The pattern may comprise a continuous or semi-continuous network 58 of the polymer resin 56 within which one or more discrete conduits 60 are arranged.

In one example of the present invention, the fibrous structures are made using a die comprising at least one filament-forming hole, and/or 2 or more and/or 3 or more rows of filament-forming holes from which filaments are spun. At least one row of holes contains 2 or more and/or 3 or more and/or 10 or more filament-forming holes. In addition to the filament-forming holes, the die comprises fluid-releasing holes, such as gas-releasing holes, in one example air-releasing holes, that provide attenuation to the filaments formed from the filament-forming holes. One or more fluid-releasing holes may be associated with a filament-forming hole such that the fluid exiting the fluid-releasing hole is parallel or substantially parallel (rather than angled like a knife-edge die) to an exterior surface of a filament exiting the filament-forming hole. In one example, the fluid exiting the fluid-releasing hole contacts the exterior surface of a filament formed from a filament-forming hole at an angle of less than 30° and/or less than 20° and/or less than 10° and/or less than 5° and/or about 0°. One or more fluid releasing holes may be arranged around a filament-forming hole. In one example, one or more fluid-releasing holes are associated with a single filament-forming hole such that the fluid exiting the one or more fluid releasing holes contacts the exterior surface of a single filament formed from the single filament-forming hole. In one example, the fluid-releasing hole permits a fluid, such as a gas, for example air, to contact the exterior surface of a filament formed from a filament-forming hole rather than contacting an inner surface of a filament, such as what happens when a hollow filament is formed.

In one example, the die comprises a filament-forming hole positioned within a fluid-releasing hole. The fluid-releasing hole 62 may be concentrically or substantially concentrically positioned around a filament-forming hole 64 such as is shown in FIG. 9.

After the fibrous structure 50 has been formed on the collection device, the fibrous structure 50 may be calendered, for example, while the fibrous structure is still on the collection device. In addition, the fibrous structure 50 may be subjected to post-processing operations such as embossing, thermal bonding, tuft-generating operations, moisture-imparting operations, and surface treating operations to form a finished fibrous structure. One example of a surface treating operation that the fibrous structure may be subjected to is the surface application of an elastomeric binder, such as ethylene vinyl acetate (EVA), latexes, and other elastomeric binders. Such an elastomeric binder may aid in reducing the lint created from the fibrous structure during use by consumers. The elastomeric binder may be applied to one or more surfaces of the fibrous structure in a pattern, especially a non-random, repeating pattern of microregions, or in a manner that covers or substantially covers the entire surface(s) of the fibrous structure.

In one example, the fibrous structure 50 and/or the finished fibrous structure may be combined with one or more other fibrous structures. For example, another fibrous structure, such as a filament-containing fibrous structure, such as a polypropylene filament fibrous structure may be associated with a surface of the fibrous structure 50 and/or the finished fibrous structure. The polypropylene filament fibrous structure may be formed by meltblowing polypropylene filaments (filaments that comprise a second polymer that may be the same or different from the polymer of the filaments in the fibrous structure 50) onto a surface of the fibrous structure 50 and/or finished fibrous structure. In another example, the polypropylene filament fibrous structure may be formed by meltblowing filaments comprising a second polymer that may be the same or different from the polymer of the filaments in the fibrous structure 50 onto a collection device to form the polypropylene filament fibrous structure. The polypropylene filament fibrous structure may then be combined with the fibrous structure 50 or the finished fibrous structure to make a two-ply fibrous structure—three-ply if the fibrous structure 50 or the finished fibrous structure is positioned between two plies of the polypropylene filament fibrous structure like that shown in FIG. 6 for example. The polypropylene filament fibrous structure may be thermally bonded to the fibrous structure 50 or the finished fibrous structure via a thermal bonding operation.

In yet another example, the fibrous structure 50 and/or finished fibrous structure may be combined with a filament-containing fibrous structure such that the filament-containing fibrous structure, such as a polysaccharide filament fibrous structure, such as a starch filament fibrous structure, is positioned between two fibrous structures 50 or two finished fibrous structures like that shown in FIG. 6 for example.

In still another example, two plies of fibrous structure 50 comprising a non-random, repeating pattern of microregions may be associated with one another such that protruding microregions, such as pillows, face inward into the two-ply fibrous structure formed.

The process for making fibrous structure 50 may be close coupled (where the fibrous structure is convolutedly wound into a roll prior to proceeding to a converting operation) or directly coupled (where the fibrous structure is not convolutedly wound into a roll prior to proceeding to a converting operation) with a converting operation to emboss, print, deform, surface treat, or other post-forming operation known to those in the art. For purposes of the present invention, direct coupling means that the fibrous structure 50 can proceed directly into a converting operation rather than, for example, being convolutedly wound into a roll and then unwound to proceed through a converting operation.

The process of the present invention may include preparing individual rolls of fibrous structure and/or sanitary tissue product comprising such fibrous structure(s) that are suitable for consumer use.

### Non-Limiting Example of Process for Making a Fibrous Structure of the Present Invention:

A 20%:27.5%47.5%:5% blend of Lyondell-Basell PH835 polypropylene: Lyondell-Basell Metocene MF650W polypropylene: Exxon-Mobil PP3546 polypropylene: Polyvel S-1416 wetting agent is dry blended, to form a melt blend. The melt blend is heated to 475° F. through a melt extruder. A 15.5 inch wide Biax 12 row spinnerette with 192 nozzles per cross-direction inch, commercially available from Biax Fiberfilm Corporation, is utilized. 40 nozzles per cross-direction inch of the 192 nozzles have a 0.018 inch inside diameter while the remaining nozzles are solid, i.e. there is no opening in the nozzle. Approximately 0.19 grams per hole per minute (ghm) of the melt blend is extruded from the open nozzles to form meltblown filaments from the melt blend. Approximately 375 SCFM of compressed air is heated such that the air exhibits a temperature of 395° F. at the spinnerette. Approximately 475 g/minute of Golden Isle (from Georgia Pacific) 4825 semi-treated SSK pulp is defibrillated through a hammermill to form SSK wood pulp fibers (solid additive). Air at 85-90° F. and 85% relative humidity (RH) is drawn into the hammermill. Approximately 1200 SCFM of air carries the pulp fibers to a solid additive spreader. The solid additive spreader turns the pulp fibers and distributes the pulp fibers in the cross-direction such that the pulp fibers are injected into the meltblown filaments in a perpendicular fashion through a 4 inch×15 inch cross-direction (CD) slot. A forming box surrounds the area where the meltblown filaments and pulp fibers are commingled. This forming box is designed to reduce the amount of air allowed to enter or escape from this commingling area; however, there is an additional 4 inch×15 inch spreader opposite the solid additive spreader designed to add cooling air. Approximately 1000 SCFM of air at approximately 80° F. is added through this additional spreader. A forming vacuum pulls air through a collection device, such as a patterned belt, thus collecting the commingled meltblown filaments and pulp fibers to form a fibrous structure comprising a pattern of non-random, repeating microregions. The fibrous structure formed by this process comprises about 75% by dry fibrous structure weight of pulp and about 25% by dry fibrous structure weight of meltblown filaments.

Optionally, a meltblown layer of the meltblown filaments (a scrim comprising filaments exhibiting a diameter of less than 10 μm) can be added to one or both sides of the above formed fibrous structure. This addition of the meltblown layer can help reduce the lint created from the fibrous structure during use by consumers and is preferably performed prior to any thermal bonding operation of the fibrous structure. The meltblown filaments for the exterior layers can be the same or different than the meltblown filaments used on the opposite layer or in the center layer(s).

The fibrous structure may be convolutedly wound to form a roll of fibrous structure. The end edges of the roll of fibrous structure may be contacted with a material to create bond regions.

### Test Methods:

Unless otherwise specified, all tests described herein including those described under the Definitions section and the following test methods are conducted on samples that have been conditioned in a conditioned room at a temperature of 73° F.±4° F. (about 23° C.±2.2° C.) and a relative humidity of 50%±10% for 2 hours prior to the test. All tests are conducted in such conditioned room. Do not test samples that have defects such as wrinkles, tears, holes, and like.

### Lint Test Method:

The amount of lint generated from a fibrous structure sample is determined with a Sutherland Rub Tester. The Sutherland Rub Tester may be obtained from Testing Machines, Inc. (Amityville, N.Y., 1701). This tester uses a motor to rub a weighted felt 5 times over the fibrous structure sample, while the fibrous structure sample is restrained in a stationary position. The Hunter Color L value is measured before and after the rub test. The difference between these two Hunter Color L values is then used to calculate a lint value.

i. Sample Preparation—The fibrous structure sample is first prepared by removing and discarding any product which might have been abraded in handling, e.g. on the outside of the roll. For products formed from multiple plies of fibrous structures, this test can be used to make a lint measurement on the multi-ply product, or, if the plies can be separated without damaging the specimen, a measurement can be taken on the individual plies making up the product. If a given sample differs from surface to surface, it is necessary to test both surfaces and average the values in order to arrive at a composite lint value. In some cases, products are made from multiple-plies of fibrous structures such that the facing-out surfaces are identical, in which case it is only necessary to test one surface. If both surfaces are to be tested, it is necessary to obtain six specimens for testing (Single surface testing only requires three specimens). Each specimen should be folded in half such that the crease is running along the cross direction (CD) of the fibrous structure sample. For two-surface testing, make up 3 samples with a first surface “out” and 3 with the second-side surface “out”. Keep track of which samples are first surface “out” and which are second surface out.

Obtain a 30 inch×40 inch piece of Crescent #300 cardboard from Cordage Inc. (800 E. Ross Road, Cincinnati, Ohio, 45217). Using a paper cutter, cut out six pieces of cardboard of dimensions of 2.25 inch×6 inch. Puncture two holes into each of the six cards by forcing the cardboard onto the hold down pins of the Sutherland Rub tester. Draw two lines parallel to the short dimension and down 1.125 inches from the top and bottom most edges on the white side of the cardboard. Carefully score the length of the line with a razor blade using a straight edge as a guide. Score it to a depth about half way through the thickness of the sheet. This scoring allows the cardboard/felt combination to fit tightly around the weight of the Sutherland Rub tester. Draw an arrow running parallel to the long dimension of the cardboard on this scored side of the cardboard.

Center and carefully place each of the 2.5 inch×6 inch cardboard pieces on top of the six previously folded samples. Make sure the 6 inch dimension of the cardboard is running parallel to the machine direction (MD) of each of the fibrous structure samples. Center and carefully place each of the cardboard pieces on top of the three previously folded samples. Once again, make sure the 6 inch dimension of the cardboard is running parallel to the machine direction (MD) of each of the fibrous structure sample.

Fold one edge of the exposed portion of the fibrous structure sample onto the back of the cardboard. Secure this edge to the cardboard with adhesive tape obtained from 3M Inc. (¾ inch wide Scotch Brand, St. Paul, Minn.). Carefully grasp the other over-hanging tissue edge and snugly fold it over onto the back of the cardboard. While maintaining a snug fit of the fibrous structure sample onto the board, tape this second edge to the back of the cardboard. Repeat this procedure for each sample.

Turn over each sample and tape the cross direction edge of the fibrous structure sample to the cardboard. One half of the adhesive tape should contact the fibrous structure sample while the other half is adhering to the cardboard. Repeat this procedure for each of the samples. If the fibrous structure sample breaks, tears, or becomes frayed at any time during the course of this sample preparation procedure, discard and make up a new sample with a new fibrous structure sample strip.

There will now be 3 first-side surface “out” samples on cardboard and 3 second-side surface “out” samples on cardboard.

ii. Felt Preparation—Cut six pieces of black felt (F-55 or equivalent from New England Gasket, 550 Broad Street, Bristol, Conn. 06010) to the dimensions of 2.25 inch×8.5 inch×0.0625 inch. Place the felt on top of the unscored, green side of the cardboard such that the long edges of both the felt and cardboard are parallel and in alignment. Make sure the fluffy side of the felt is facing up. Also allow about 0.5 inches to overhang the top and bottom most edges of the cardboard. Snugly fold over both overhanging felt edges onto the backside of the cardboard with Scotch brand tape. Prepare a total of six of these felt/cardboard combinations.

iii. Care of 4 Pound Weight—A four pound weight is used. The four pound weight has four square inches of effective contact area providing a contact pressure of one pound per square inch. Since the contact pressure can be changed by alteration of the rubber pads mounted on the face of the weight, it is important to use only the rubber pads supplied by the manufacturer (Brown Inc., Mechanical Services Department, Kalamazoo, Mich.). These pads must be replaced if they become hard, abraded or chipped off. When not in use, the weight must be positioned such that the pads are not supporting the full weight of the weight. It is best to store the weight on its side.

iv. Rub Tester Instrument Calibration—The Sutherland Rub Tester must first be calibrated prior to use. First, turn on the Sutherland Rub Tester by moving the tester switch to the “cont” position. When the tester arm is in its position closest to the user, turn the tester's switch to the “auto” position. Set the tester to run 5 strokes (back and forth) at a rate of 42 cycles/minute by moving the pointer arm on the large dial to the “five” position setting. One stroke is a single and complete forward and reverse motion of the weight. The end of the rubbing block should be in the position closest to the operator at the beginning and at the end of each test.

Prepare a test specimen on cardboard sample as described above. In addition, prepare a felt on cardboard sample as described above. Both of these samples will be used for calibration of the instrument and will not be used in the acquisition of data for the actual samples.

Place this calibration fibrous structure sample on the base plate of the tester by slipping the holes in the board over the hold-down pins. The hold-down pins prevent the sample from moving during the test. Clip the calibration felt/cardboard sample onto the four pound weight with the cardboard side contacting the pads of the weight. Make sure the cardboard/felt combination is resting flat against the weight. Hook this weight onto the tester arm and gently place the fibrous structure sample underneath the weight/felt combination. The end of the weight closest to the operator must be over the cardboard of the fibrous structure sample and not the fibrous structure sample itself. The felt must rest flat on the fibrous structure sample and must be in 100% contact with the fibrous structure sample surface. Activate the tester by depressing the “push” button.

Keep a count of the number of strokes and observe and make a mental note of the starting and stopping position of the felt covered weight in relationship to the sample. If the total number of strokes is five and if the end of the felt covered weight closest to the operator is over the cardboard of the fibrous structure sample at the beginning and end of this test, the tester is calibrated and ready to use. If the total number of strokes is not five or if the end of the felt covered weight closest to the operator is over the actual fibrous structure sample either at the beginning or end of the test, repeat this calibration procedure until 5 strokes are counted the end of the felt covered weight closest to the operator is situated over the cardboard at the both the start and end of the test. During the actual testing of samples, monitor and observe the stroke count and the starting and stopping point of the felt covered weight. Recalibrate when necessary.

v. Hunter Color Meter Calibration—Adjust the Hunter Color Difference Meter for the black and white standard plates according to the procedures outlined in the operation manual of the instrument. Also run the stability check for standardization as well as the daily color stability check if this has not been done during the past eight hours. In addition, the zero reflectance must be checked and readjusted if necessary. Place the white standard plate on the sample stage under the instrument port. Release the sample stage and allow the sample plate to be raised beneath the sample port. Using the “L-Y”, “a-X”, and “b-Z” standardizing knobs, adjust the instrument to read the Standard White Plate Values of “L”, “a”, and “b” when the “L”, “a”, and “b” push buttons are depressed in turn.

vi. Measurement of Samples—The first step in the measurement of lint is to measure the Hunter color values of the black felt/cardboard samples prior to being rubbed on the fibrous structure sample. The first step in this measurement is to lower the standard white plate from under the instrument port of the Hunter color instrument. Center a felt covered cardboard, with the arrow pointing to the back of the color meter, on top of the standard plate. Release the sample stage, allowing the felt covered cardboard to be raised under the sample port.

Since the felt width is only slightly larger than the viewing area diameter, make sure the felt completely covers the viewing area. After confirming complete coverage, depress the L push button and wait for the reading to stabilize. Read and record this L value to the nearest 0.1 unit.

If a D25D2A head is in use, lower the felt covered cardboard and plate, rotate the felt covered cardboard 90 degrees so the arrow points to the right side of the meter. Next, release the sample stage and check once more to make sure the viewing area is completely covered with felt. Depress the L push button. Read and record this value to the nearest 0.1 unit. For the D25D2M unit, the recorded value is the Hunter Color L value. For the D25D2A head where a rotated sample reading is also recorded, the Hunter Color L value is the average of the two recorded values.

Measure the Hunter Color L values for all of the felt covered cardboards using this technique. If the Hunter Color L values are all within 0.3 units of one another, take the average to obtain the initial L reading. If the Hunter Color L values are not within the 0.3 units, discard those felt/cardboard combinations outside the limit. Prepare new samples and repeat the Hunter Color L measurement until all samples are within 0.3 units of one another.

For the measurement of the actual fibrous structure sample/cardboard combinations, place the fibrous structure sample/cardboard combination on the base plate of the tester by slipping the holes in the board over the hold-down pins. The hold-down pins prevent the sample from moving during the test. Clip the calibration felt/cardboard sample onto the four pound weight with the cardboard side contacting the pads of the weight. Make sure the cardboard/felt combination is resting flat against the weight Hook this weight onto the tester arm and gently place the fibrous structure sample underneath the weight/felt combination. The end of the weight closest to the operator must be over the cardboard of the fibrous structure sample and not the fibrous structure sample itself. The felt must rest flat on the fibrous structure sample and must be in 100% contact with the fibrous structure sample surface.

Next, activate the tester by depressing the “push” button. At the end of the five strokes (back and forth) at a rate of 42 cycles/minute the tester will automatically stop. Note the stopping position of the felt covered weight in relation to the sample. If the end of the felt covered weight toward the operator is over cardboard, the tester is operating properly. If the end of the felt covered weight toward the operator is over sample, disregard this measurement and recalibrate as directed above in the Sutherland Rub Tester Calibration section.

Remove the weight with the felt covered cardboard. Inspect the fibrous structure sample. If torn, discard the felt and fibrous structure sample and start over. If the fibrous structure sample is intact, remove the felt covered cardboard from the weight. Determine the Hunter Color L value on the felt covered cardboard as described above for the blank felts. Record the Hunter Color L readings for the felt after rubbing. Rub, measure, and record the Hunter Color L values for all remaining samples. After all fibrous structure samples have been measured, remove and discard all felt. Felts strips are not used again. Cardboards are used until they are bent, torn, limp, or no longer have a smooth surface.

vii. Calculations—Determine the delta L values by subtracting the average initial L reading found for the unused felts from each of the measured values for the first-side surface and second-side surface sides of the sample as follows.

For samples measured on both surfaces, subtract the average initial L reading found for the unused felts from each of the three first-side surface L readings and each of the three second-side surface L readings. Calculate the average delta for the three first-side surface values. Calculate the average delta for the three second-side surface values. Subtract the felt factor from each of these averages. The final results are termed a lint for the first-side surface and a lint for the second-side surface of the fibrous structure sample.

By taking the average of the lint value on the first-side surface and the second-side surface, the lint is obtained which is applicable to that particular fibrous structure sample. In other words, to calculate lint value, the following formula is used:

$$Lint Value = \frac{Lint Value , first \text{-} side + Lint Value , second \text{-} side}{2}$$

For samples measured only for one surface, subtract the average initial L reading found for the unused felts from each of the three L readings. Calculate the average delta for the three surface values. Add 1.1 to this average to arrive at the reported Dry lint score for that particular fibrous structure sample.

The Dry Lint Score Differential is calculated as the difference between the averaged lint values from the first-side and second-side surfaces of the fibrous structure.

### Vertical Full Sheet (VFS) Test Method

The Vertical Full Sheet (VFS) test method determines the amount of distilled water absorbed and retained by a fibrous structure of the present invention. This method is performed by first weighing a sample of the fibrous structure to be tested (referred to herein as the “dry weight of the sample”), then thoroughly wetting the sample, draining the wetted sample in a vertical position and then reweighing (referred to herein as “wet weight of the sample”). The absorptive capacity of the sample is then computed as the amount of water retained in units of grams of water absorbed by the sample. When evaluating different fibrous structure samples, the same size of fibrous structure is used for all samples tested.

The apparatus for determining the VFS capacity of fibrous structures comprises the following:

1) An electronic balance with a sensitivity of at least ±0.01 grams and a minimum capacity of 1200 grams. The balance should be positioned on a balance table and slab to minimize the vibration effects of floor/benchtop weighing. The balance should also have a special balance pan to be able to handle the size of the sample tested (i.e.; a fibrous structure sample of about 11 in. by 11 in.). The balance pan can be made out of a variety of materials. Plexiglass is a common material used.

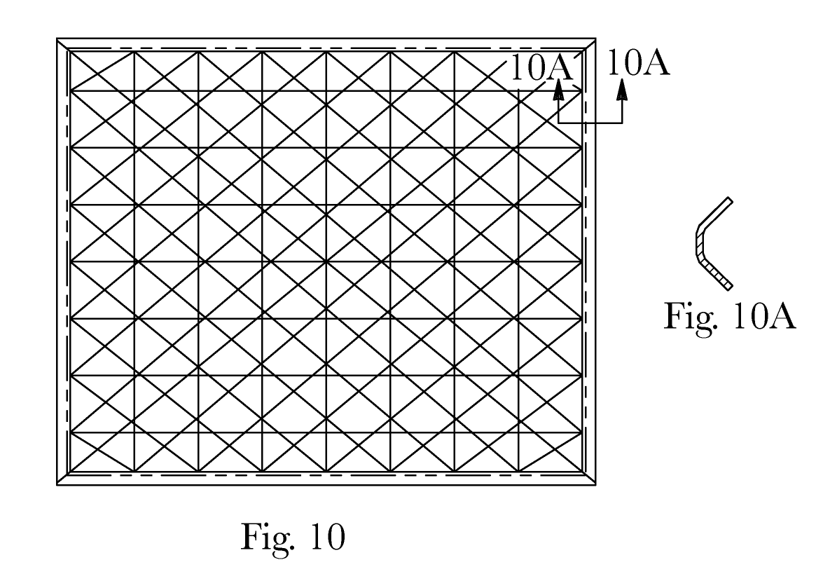

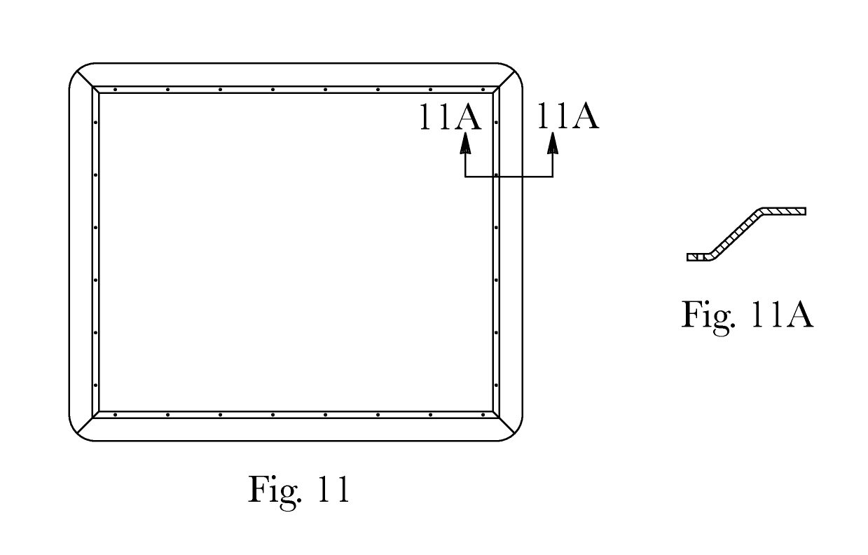

2) A sample support rack (FIGS. 10 and 10A) and sample support rack cover (FIGS. 11 and 11A) is also required. Both the rack and cover are comprised of a lightweight metal frame, strung with 0.012 in. diameter monofilament so as to form a grid as shown in FIG. 10. The size of the support rack and cover is such that the sample size can be conveniently placed between the two.

The VFS test is performed in an environment maintained at 23±1° C. and 50±2% relative humidity. A water reservoir or tub is filled with distilled water at 23±1° C. to a depth of 3 inches.

Eight 7.5 inch×7.5 inch to 11 inch×11 inch samples of a fibrous structure to be tested are carefully weighed on the balance to the nearest 0.01 grams. The dry weight of each sample is reported to the nearest 0.01 grams. The empty sample support rack is placed on the balance with the special balance pan described above. The balance is then zeroed (tared). One sample is carefully placed on the sample support rack. The support rack cover is placed on top of the support rack. The sample (now sandwiched between the rack and cover) is submerged in the water reservoir. After the sample is submerged for 60 seconds, the sample support rack and cover are gently raised out of the reservoir.

The sample, support rack and cover are allowed to drain vertically (at angle greater than 60° but less than 90° from horizontal) for 60±5 seconds, taking care not to excessively shake or vibrate the sample. While the sample is draining, the rack cover is removed and excess water is wiped from the support rack. The wet sample and the support rack are weighed on the previously tared balance. The weight is recorded to the nearest 0.01 g. This is the wet weight of the sample.

The procedure is repeated for with another sample of the fibrous structure, however, the sample is positioned on the support rack such that the sample is rotated 90° in plane compared to the position of the first sample on the support rack.

The gram per fibrous structure sample absorptive capacity of the sample is defined as (wet weight of the sample−dry weight of the sample). The calculated VFS is the average of the absorptive capacities of the two samples of the fibrous structure.

### Basis Weight Test Method

Basis weight of a fibrous structure sample is measured by selecting twelve (12) individual fibrous structure samples and making two stacks of six individual samples each. If the individual samples are connected to one another vie perforation lines, the perforation lines must be aligned on the same side when stacking the individual samples. A precision cutter is used to cut each stack into exactly 3.5 in.×3.5 in. squares. The two stacks of cut squares are combined to make a basis weight pad of twelve squares thick. The basis weight pad is then weighed on a top loading balance with a minimum resolution of 0.01 g. The top loading balance must be protected from air drafts and other disturbances using a draft shield. Weights are recorded when the readings on the top loading balance become constant. The Basis Weight is calculated as follows:

$$Basis Weight ( lbs \text{/} 3000 {ft}^{2} ) = \frac{Weight of basis weight pad ( g ) \times 3000 {ft}^{2}}{\begin{matrix}453.6 g \text{/} lbs \times 12 samples \times \\ [ 12.25 {in}^{2} ( Area of basis weight pad ) / 144 {in}^{2} ]\end{matrix}}$$

$$Basis Weight ( g \text{/} {m}^{2} ) = \frac{Weight of basis weight pad ( g ) \times 10 , 000 {cm}^{2} \text{/} {m}^{2}}{79.0321 {cm}^{2} ( Area of basis weight pad ) \times 12 samples}$$

The level of filaments present in a fibrous structure having an initial basis weight can be determined by measuring the filament basis weight of a fibrous structure by using the Basis Weight Test Method after separating all non-filament materials from a fibrous structure. Different approaches may be used to achieve this separation. For example, non-filament material may be dissolved in an appropriate dissolution agent, such as sulfuric acid or Cadoxen, leaving the filaments in tact with their mass essentially unchanged. The filaments are then weighed. The weight percentage of filaments present in the fibrous structure is then determined by the equation:

% wt. Filaments=100*(Filament Mass/Initial Basis Weight of Fibrous Structure)

The % wt. Solid Additives present in the fibrous structure can then be determined by subtracting the % wt. Filaments from 100% to arrive at the % wt. Solid Additives.

### Caliper Test Method

Caliper of a fibrous structure is measured by cutting five (5) samples of fibrous structure such that each cut sample is larger in size than a load foot loading surface of a VIR Electronic Thickness Tester Model II available from Thwing-Albert Instrument Company, Philadelphia, Pa. Typically, the load foot loading surface has a circular surface area of about 3.14 in². The sample is confined between a horizontal flat surface and the load foot loading surface. The load foot loading surface applies a confining pressure to the sample of 95 g/in². The caliper of each sample is the resulting gap between the flat surface and the load foot loading surface. The caliper is calculated as the average caliper of the five samples. The result is reported in millimeters (mm).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fibrous structure comprising a plurality of filaments and a plurality of solid additives wherein the fibrous structure exhibits a lint value of less than 2.5, and wherein the filaments are present in the fibrous structure at a level of less than 30% by weight of the fibrous structure.

2. The fibrous structure according to claim 1 wherein the filaments comprise thermoplastic filaments.

3. The fibrous structure according to claim 2 wherein the thermoplastic filaments comprise a polymer selected from the group consisting of: polypropylene, polyethylene, polyester, and mixtures thereof.

4. The fibrous structure according to claim 1 wherein the solid additives comprise fibers.

5. The fibrous structure according to claim 4 wherein the fibers comprise pulp fibers.

6. The fibrous structure according to claim 5 wherein the pulp fibers are selected from the group consisting of hardwood pulp fibers, softwood pulp fibers and mixtures thereof.

7. The fibrous structure according to claim 6 wherein the pulp fibers comprise eucalyptus pulp fibers.

8. The fibrous structure according to claim 6 wherein the pulp fibers comprise chemically treated pulp fibers.

9. The fibrous structure according to claim 1 wherein the fibrous structure is a co-formed fibrous structure.

10. The fibrous structure according to claim 1 wherein the fibrous structure further comprises a scrim.

11. The fibrous structure according to claim 10 wherein the scrim comprises filaments the exhibit a diameter of less than 10 μm.

12. The fibrous structure according to claim 1 wherein the fibrous structure exhibits a basis weight of from about 10 g/m² to about 120 g/m².

13. A sanitary tissue product comprising a fibrous structure according to claim 1.

14. The sanitary tissue product according to claim 13 wherein the sanitary tissue product is in a roll form.

15. A method for making a fibrous structure according to claim 1, the method comprising the step of combining a plurality of filaments and a plurality of solid additives such that a fibrous structure containing less than 30% by weight of the fibrous structure of filaments and exhibits a dry lint score of less than 2.5 is formed.

16. A fibrous structure comprising a plurality of filaments and a plurality of solid additives, wherein the fibrous structure exhibits a lint value of less than 2.5 and a VFS of greater than 11 g/g.

17. The fibrous structure according to claim 15 wherein the filaments comprise thermoplastic filaments.

18. The fibrous structure according to claim 15 wherein the solid additives comprise fibers.

19. The fibrous structure according to claim 17 wherein the fibers comprise pulp fibers.

20. The fibrous structure according to claim 15 wherein the fibrous structure is a co-formed fibrous structure.

21. The fibrous structure according to claim 15 wherein the fibrous structure exhibits a basis weight of from about 10 g/m² to about 120 g/m².

22. A sanitary tissue product comprising a fibrous structure according to claim 15.

23. A method for making a fibrous structure according to claim 15, the method comprising the step of combining a plurality of filaments and a plurality of solid additives such that a fibrous structure that exhibits a dry lint score of less than 2.5 and a VFS of greater than 11 g/g is formed.

24. A fibrous structure comprising a plurality of filaments and a plurality of solid additives, wherein the fibrous structure exhibits a dry lint score differential between two surfaces of the fibrous structure of less than 0.5 and wherein the filaments are present in the fibrous structure at a level of less than 30% by weight of the fibrous structure.

25. The fibrous structure according to claim 23 wherein the filaments comprise thermoplastic filaments.

26. The fibrous structure according to claim 23 wherein the solid additives comprise fibers.

27. The fibrous structure according to claim 25 wherein the fibers comprise pulp fibers.

28. The fibrous structure according to claim 23 wherein the fibrous structure is a co-formed fibrous structure.

29. The fibrous structure according to claim 23 wherein the fibrous structure exhibits a basis weight of from about 10 g/m² to about 120 g/m².

30. A sanitary tissue product comprising a fibrous structure according to claim 23.

31. A method for making a fibrous structure according to claim 23, the method comprising the step of combining a plurality of filaments and a plurality of solid additives such that a fibrous structure containing less than 30% by weight of the fibrous structure of filaments and exhibits a dry lint score differential of less than 0.5 is formed.

32. A fibrous structure comprising a plurality of filaments and a plurality of solid additives, wherein the fibrous structure exhibits a dry lint score differential between two surfaces of the fibrous structure of less than 0.5 and wherein the fibrous structure exhibits VFS of greater than 11 g/g.

33. The fibrous structure according to claim 31 wherein the filaments comprise thermoplastic filaments.

34. The fibrous structure according to claim 31 wherein the solid additives comprise fibers.

35. The fibrous structure according to claim 33 wherein the fibers comprise pulp fibers.

36. The fibrous structure according to claim 31 wherein the fibrous structure is a co-formed fibrous structure.

37. The fibrous structure according to claim 31 wherein the fibrous structure exhibits a basis weight of from about 10 g/m² to about 120 g/m².

38. A sanitary tissue product comprising a fibrous structure according to claim 31.

39. A method for making a fibrous structure according to claim 31, the method comprising the step of combining a plurality of filaments and a plurality of solid additives such that a fibrous structure that exhibits a dry lint score differential of less than 0.5 and a VFS of greater than 11 g/g is formed.
